(19) United States
(12) Patent Application Publication
(10) Pub. No.: US 2026/0076392 A1
(43) Pub. Date: Mar. 19, 2026

(54) ICE-MAKING ASSEMBLY APPLIED TO SLUSHIE AND ICE CREAM MACHINE

(71) Applicant: Zhongshan Meta-Cool Intelligent Technology Co., Ltd, Zhongshan (CN)

(72) Inventors: Yuekang HE, Zhongshan (CN); YAN SAI IU, Zhongshan (CN); Zhuonan PAN, Zhongshan (CN); Zhanting ZHOU, Zhongshan (CN)

(73) Assignee: Zhongshan Meta-Cool Intelligent Technology Co., Ltd, Zhongshan (CN)

(21) Appl. No.: 19/193,906

(22) Filed: Apr. 29, 2025

(30) Foreign Application Priority Data
Sep. 13, 2024 (CN) 202411283747.2

(51) Int. Cl. A23G 9/22; A23G 9/04; A23G 9/12

(52) U.S. Cl. CPC A23G 9/22; A23G 9/045; A23G 9/12; A23G 9/224; A23G 9/228

(57) ABSTRACT

A shaved ice machine and an ice-making assembly applied to a shaved ice machine are provided. The ice-making assembly is configured in an ice-making cavity of the shaved ice machine. The ice-making assembly includes an evaporation pipe and a cold conduction sleeve. The evaporation pipe is provided with a liquid inlet end and a liquid outlet end. The cold conduction sleeve is tightly wrapped outside the evaporation pipe so that only the liquid inlet end and the liquid outlet of the evaporation pipe are exposed to the cold conduction sleeve. The cold conduction sleeve is made of a cold conduction material. The ice-making assembly accommodated in the ice-making cavity and used for converting a liquid beverage form into a slushy ice particle form is provided with an evaporation pipe and a cold conduction sleeve.

### RELATED APPLICATIONS

The present patent document claims the benefit of priority to Patent Application No. 202411283747.2, filed Sep. 13, 2024, and entitled “ICE-MAKING ASSEMBLY APPLIED TO SLUSHIE AND ICE CREAM MACHINE,” the entire contents of each of which are incorporated herein by reference.

### BACKGROUND

### 1. Technical Field

The present disclosure relates to a shaved ice machine, in particular to an ice-making assembly applied to a shaved ice machine and a shaved ice machine.

### 2. Background Information

The shaved ice machine is an electrical device that converts liquid beverage into slushy ice particles for human consumption. The existing shaved ice machine includes a machine body and an ice-making mechanism. An ice-making cavity is formed in the machine body. The ice-making mechanism includes an evaporation barrel, a compressor and a condenser. An evaporation pipe, the compressor and the condenser are connected through a refrigeration pipeline to form a refrigeration loop for a condensate to flow circularly. The evaporation barrel is accommodated in the ice-making cavity for converting liquid beverage into slushy ice particles for human consumption. Wherein, the evaporation barrel includes a barrel shell, an evaporation pipe arranged in the barrel shell and a foaming material filling gaps in the barrel shell. The evaporation pipe is formed by winding a metal pipe through bolts. When the evaporation pipe is assembled in the barrel shell, the side, opposite to the inner wall of the barrel shell, of the metal pipe abuts against the inner wall of the barrel shell, thereby realizing heat conduction between the evaporation pipe and the barrel shell. The outer wall of the evaporation pipe abuts against the inner wall of the barrel shell so that the evaporation pipe realizes heat conduction. The evaporation pipe is formed by winding a metal pipe through bolts, and the flatness of its outer wall is poor, resulting in point contact (non-surface contact) between the evaporation pipe and the inner wall of the barrel shell, small contact area and low cold conduction efficiency.

### BRIEF SUMMARY

The present disclosure aims to provide an ice-making assembly applied to a shaved ice machine so as to solve the problem of low cold conduction efficiency due to the fact that the contact area of an evaporation pipe and an inner wall of a barrel shell is small in an evaporation barrel of the existing shaved ice machine.

The present disclosure is realized through the following technical scheme.

An ice-making assembly applied to a shaved ice machine, configured in an ice-making cavity of a shaved ice machine, includes an evaporation pipe and a cold conduction sleeve. The evaporation pipe is provided with a liquid inlet end and a liquid outlet end. The cold conduction sleeve is tightly wrapped outside the evaporation pipe so that only the liquid inlet end and the liquid outlet of the evaporation pipe are exposed to the cold conduction sleeve. The cold conduction sleeve is made of a cold conduction material.

Further, the ice-making assembly applied to a shaved ice machine further includes a housing. An assembly cavity matched with the shape of the cold conduction sleeve for placing the cold conduction sleeve is formed in the housing. The housing is made of a heat conduction material.

Further, the ice-making assembly applied to a shaved ice machine further includes a cold conduction material filled between an inner wall of the assembly cavity and an outer wall of the cold conduction sleeve; and/or the housing is provided with a fastener for locking the housing on the cold conduction sleeve.

Further, an axial through hole extending along the axial direction of the cold conduction sleeve is formed in the cold conduction sleeve. A hole wall of the axial through hole is defined as an inner cold conduction surface, and an outer wall of the cold conduction sleeve is defined as an outer cold conduction sleeve. The evaporation pipe is located between the inner cold conduction surface and the outer cold conduction surface.

Further, the cold conduction sleeve or the housing is provided with a temperature sensor.

Further, the evaporation pipe extends to the liquid outlet end from the liquid inlet end around the cold conduction sleeve in an axial direction of the cold conduction sleeve.

In order to solve the problem of low cold conduction efficiency due to the fact that the contact area of an evaporation pipe and an inner wall of a barrel shell is small in an evaporation barrel of the existing shaved ice machine, the present disclosure provides an ice-making assembly applied to a shaved ice machine. Correspondingly, a shaved ice machine includes a machine body and an ice-making mechanism arranged in the machine body. An ice-making cavity is formed in the machine body. The ice-making mechanism includes an ice-making assembly accommodated in the ice-making cavity. The ice-making assembly is the ice-making assembly applied to a shaved ice machine.

Further, the machine body is provided with a stirring mechanism. The stirring mechanism includes an outer stirring rod accommodated in the ice-making cavity and capable of rotating relative to the cold conduction sleeve. The outer stirring rod spirally extends along an outer wall of the cold conduction sleeve in an axial direction of the cold conduction sleeve.

Further, an axial through hole extending along an axial direction of the cold conduction sleeve is formed in the cold conduction sleeve. A hole wall of the axial through hole is defined as an inner cold conduction surface, and an outer wall of the cold conduction sleeve is defined as an outer cold conduction surface. The evaporation pipe is located between the inner cold conduction surface and the outer cold conduction surface. The machine body is provided with a stirring mechanism. The stirring mechanism includes an outer stirring rod accommodated in the ice-making cavity and capable of rotating relative to the cold conduction sleeve and an inner stirring rod. The outer stirring rod spirally extends along the outer cold conduction surface in the axial direction of the cold conduction sleeve. The inner stirring rod spirally extends along the inner cold conduction surface in the axial direction of the cold conduction sleeve.

Further, the ice-making assembly further includes a housing. An assembly cavity matched with the shape of the cold conduction sleeve for placing the cold conduction sleeve is formed in the housing. The machine body is provided with a stirring mechanism. The stirring mechanism includes an outer stirring rod accommodated in the ice-making cavity and capable of rotating relative to the housing. The outer stirring rod spirally extends along an outer wall of the housing in an axial direction of the housing.

The technical scheme has the following advantages. The ice-making assembly accommodated in the ice-making cavity and used for converting a liquid beverage form into a slushy ice particle form is provided with an evaporation pipe and a cold conduction sleeve. The cold conduction sleeve is made of a cold conduction material and is tightly wrapped outside the evaporation pipe so that only the liquid inlet end and the liquid outlet end of the evaporation pipe are exposed to the cold conduction sleeve. The evaporation pipe is in full contact with the cold conduction sleeve. The cold conduction contact surface is large, the heat conduction conversion rate is high, and the cold conduction effect is good. Therefore, the cold conduction sleeve has good refrigeration effect and accelerates the conversion of liquid beverage form.

### BRIEF DESCRIPTION OF THE DRAWINGS

To describe the technical solutions in the embodiments of this application more clearly, the following briefly describes the attached figures required for describing the embodiments. Apparently, the attached figures in the following description show merely some embodiments of this application, and a person of ordinary skill in the art may derive other drawings from these attached figures without creative efforts.

To describe technical solutions in embodiments of the present disclosure more clearly, the following briefly describes the attached figures required for describing the embodiments.

FIG. 1 is a structure diagram of a shaved ice machine disclosed by the first embodiment.

FIG. 2 is a space diagram of an ice-making assembly in the first embodiment.

FIG. 3 is a breakdown drawing of an ice-making assembly in the first embodiment.

FIG. 4 is an assembly diagram of an ice-making assembly of an ice-making assembly, an inner stirring rod and an outer stirring rod in the first embodiment.

FIG. 5 is a space diagram of an ice-making assembly in the second embodiment.

FIG. 6 is a breakdown drawing of an ice-making assembly in the second embodiment.

FIG. 7 is an assembly diagram of an ice-making assembly and an outer stirring rod in the second embodiment.

FIG. 8 is a space diagram of an ice-making assembly in the third embodiment.

FIG. 9 is a breakdown drawing of an ice-making assembly in the third embodiment.

### DETAILED DESCRIPTION OF THE DRAWINGS AND THE PRESENTLY PREFERRED EMBODIMENTS

The following clearly and completely describes the technical scheme in the embodiments of the present disclosure with reference to the embodiments of the present disclosure. Apparently, the described embodiments are merely a part rather than all of the embodiments of the present disclosure. Based on the embodiment in the present disclosure, all other embodiments obtained by the ordinary technical staff in the art under the premise of without contributing creative labor belong to the scope protected by the present disclosure.

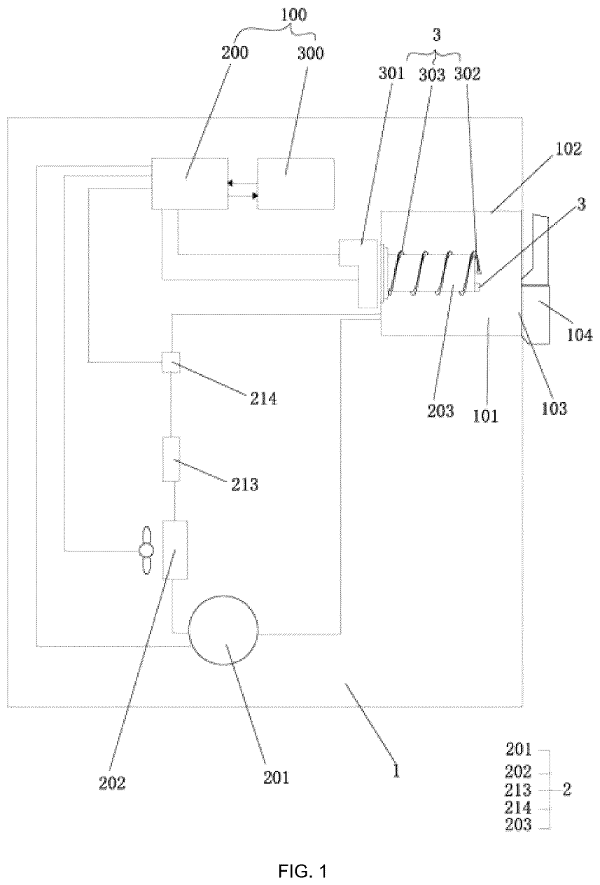

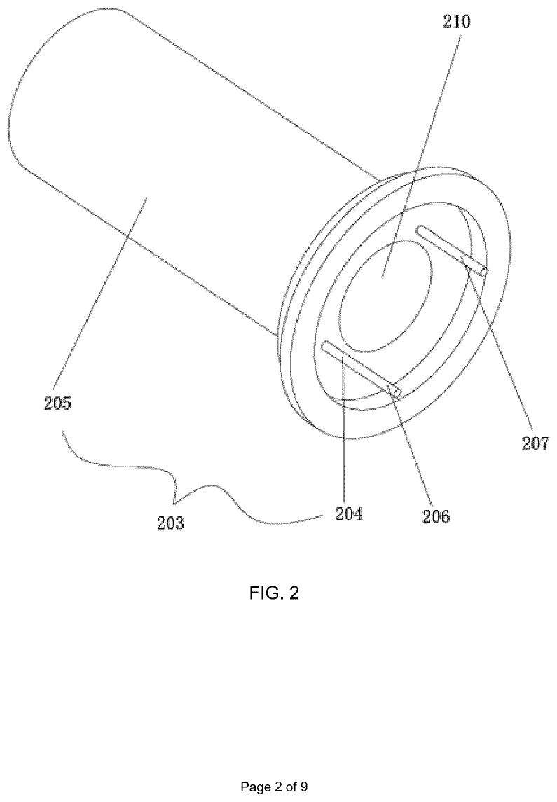

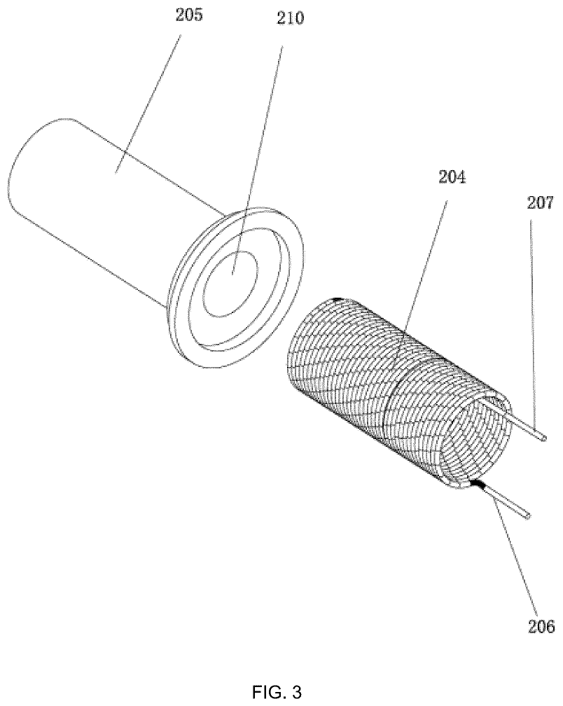

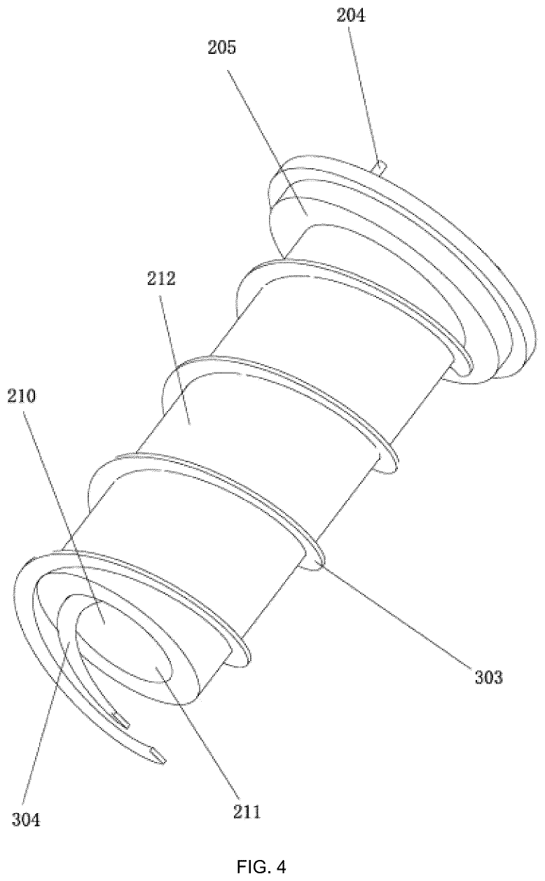

In the first embodiment, as shown in FIG. 1 to FIG. 4, the shaved ice machine includes a machine body 1, an ice-making mechanism 2 arranged in the machine body 1 and a stirring mechanism 3 arranged in the machine body 1. An ice-making cavity 101 is formed in the machine body 1. the ice-making mechanism 2 includes a compressor 201, a condenser 202 and an ice-making assembly 203. The ice-making assembly 203 is accommodated in the ice-making cavity 101 and used for converting a liquid beverage form into a slushy ice particle form. The ice-making mechanism 203 includes an evaporation pipe 204 and a cold conduction sleeve 205. The evaporation pipe 204 is provided with a liquid inlet end 206 and a liquid outlet end 207. The cold conduction sleeve 205 is tightly wrapped outside the evaporation pipe 204 so that only the liquid inlet end 206 and the liquid outlet 207 of the evaporation pipe 204 are exposed to the cold conduction sleeve 205, and the cold conduction sleeve 205 is made of a cold conduction material. Specifically, the cold conduction sleeve 205 may be made of, but is not limited to, a cold conduction metal material or a cold conduction non-metal material (ceramic or the like). Wherein, the compressor 201, the condenser 202 and the evaporation pipe 204 are connected through a refrigeration pipeline to form a refrigeration loop for a condensate to circularly flow. The evaporation pipe 204 is connected into the refrigeration loop through the liquid inlet end 206 and the liquid outlet end 207.

More specifically, the refrigeration loop is further provided with a dry filter 213 and an electric valve 214 located on the side of the condenser 202. The electric valve 214 is used for opening and closing the refrigeration loop. Wherein, the electric valve 214 is used for quickly balancing the pressure differential in the pipe.

The electric valve 214 is a preferred arrangement, an optional feature, and may be omitted in some embodiments.

More specifically, the machine body 1 is further provided with a controller 100. The ice-making mechanism 2 and the stirring mechanism 3 are controlled by the controller 100. The controller 100 is integrated with a control main board 200 and a visual operation interface 300.

The embodiment provides a shaved ice machine to solve the problem of low cold conduction efficiency due to the fact that the contact area between the evaporation pipe and an inner wall of a barrel shell is small in an evaporating barrel in an existing shaved ice machine. The ice-making assembly 203 accommodated in the ice-making cavity 101 and used for converting a liquid beverage form into a slushy ice particle form is provided with an evaporation pipe 204 and a cold conduction sleeve 205. The cold conduction sleeve 205 is made of a cold conduction material and is tightly wrapped outside the evaporation pipe 204 so that only the liquid inlet end 206 and the liquid outlet end 207 of the evaporation pipe 204 are exposed to the cold conduction sleeve 205. The evaporation pipe 204 is in full contact with the cold conduction sleeve 205. The cold conduction contact surface is large, the heat conduction conversion rate is high, and the cold conduction effect is good. Therefore, the cold conduction sleeve 205 has good refrigeration effect and accelerates the conversion of liquid beverage form.

Wherein, the pipe laying mode of the cold conduction sleeve 205 includes, but is not limited to, insert pressure casting and insert pipe casting.

In the first embodiment of the present disclosure, the machine body 1 includes an ice-making barrel 102. An ice-making cavity 101 is formed in the ice-making barrel 102. The stirring mechanism 3 includes a motor 301, a rotating shaft 302, an outer stirring rod 303 and an inner stirring rod 304. An axial through hole 210 extending along an axial direction of the cold conduction sleeve 205 is formed in the cold conduction sleeve 205. A hole wall of the axial through hole 210 is defined as an inner cold conduction surface 211. An outer wall of the cold conduction sleeve 205 is defined as an outer cold conduction surface 212. The evaporation pipe 204 is located between the inner cold conduction surface 211 and the outer cold conduction surface 212. The outer stirring rod 303 spirally extends along the outer cold conduction surface 212 in the axial direction of the cold conduction sleeve 205. The inner stirring rod 304 spirally extends along the inner cold conduction surface 211 in the axial direction of the cold conduction sleeve 205. The motor 301 is arranged outside the ice-making barrel 102. The rotating shaft 302 is in transmission connection to the motor 301, and stretches into the ice-making cavity 101 from the axial through hole 201 to be connected with the outer stirring rod 303 and the inner stirring rod 304. The outer stirring rod 303 and the inner stirring rod 304 are driven by the motor 301 to rotate relative to the cold conduction sleeve 205. The outer stirring rod 303 spirally extending along the outer cold conduction surface 212 in the axial direction of the cold conduction sleeve 205 and the inner stirring rod 304 spirally extending along the inner cold conduction surface 211 in the axial direction of the cold conduction sleeve 205 are arranged in the ice-making cavity 101, so that beverage converted into ice particles is always in an irregular motion state and cannot be increased under the effect of the outer stirring rod 303 and the inner stirring rod 304. The beverage is always in a crystalline state like sand particles, and is good in edible effect. At the same time, the cold conduction sleeve 205 is provided with an outer cold conduction surface 212 and an inner cold conduction surface 211 which are opposite radially, so the contact area of the cold conduction sleeve 205 and the beverage is increased, and cooling crystallization of the beverage is facilitated.

Wherein, the outer stirring rod 303 and the inner stirring rod 304 can be configured in the ice-making cavity 101 at the same time, or only the outer stirring rod 303 is configured in the ice-making cavity 101. The cold conduction effect and ice-making efficiency are better when the outer stirring rod 303 and the inner stirring rod 304 can be configured in the ice-making cavity 101 at the same time compared with when only the outer stirring rod 303 is configured in the ice-making cavity 101.

In the first embodiment of the present disclosure, the liquid inlet end 206 and the liquid outlet end 207 are arranged on the same side, and are both located at the back of the evaporation pipe 204. The outer stirring rod 303 and/or the inner stirring rod 304 drive shaved ice (beverage converted into ice particles) to move from back to front during rotating. The shaved ice is driven by the outer stirring rod 303 and/or the inner stirring rod 304 to move from back to front, and the condensate flows to a front end of the cold conduction sleeve 205 from the liquid inlet end 206 and flows back to the liquid outlet end 207 in a circumferential manner, so the temperature is gradually reduced from back to front, and the arrangement is reasonable.

Of course, the set positions of the liquid inlet end 206 and the liquid outlet end 207, and the ice discharge direction of the outer stirring rod 303 and/or the inner stirring rod 304 include but are not limited to the above settings. Further, the liquid inlet end 206 and the liquid outlet end 207 are arranged on the same side and are both located behind the evaporation pipe 204. The outer stirring rod 303 and/or the inner stirring rod 304 drive shaved ice to move from front to back during rotating.

In the first embodiment of the present disclosure, the ice barrel 102 is provided with an ice outlet hole 103 and a stop plate 104 for opening and closing the ice outlet hole 103 on the side of the outer stirring rod 303 and/or the inner stirring rod 304. The outer stirring rod 303 and/or the inner stirring rod 304 can drive the beverage converted into ice particles to move toward the ice outlet hole 103. When the stop plate 104 is overturned to open the ice outlet hole 103, the beverage converted into ice particles is driven by the outer stirring rod 303 and/or the inner stirring rod 304 to move out of the ice-making cavity 101 to realize ice discharge. The ice discharge is simple in structure and convenient to implement.

In the first embodiment of the present disclosure, the evaporation pipe 204 extends to the liquid outlet end 207 in a threaded manner from the liquid inlet end 206 around the axis of the cold conduction sleeve 205 in the axial direction of the cold conduction sleeve 205. Through the arrangement, the evaporation pipe 204 is configured into a spiral barrel shape, so that the evaporation pipe 204 has a good refrigeration effect.

In the first embodiment of the present disclosure, the cold conduction sleeve 205 is provided with a temperature sensor 3.

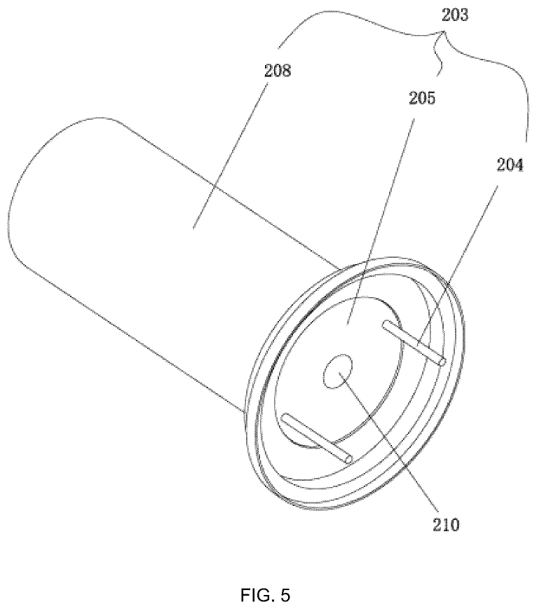

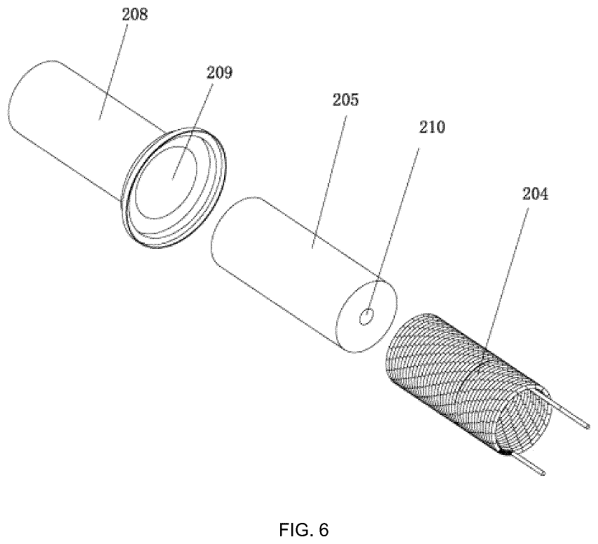

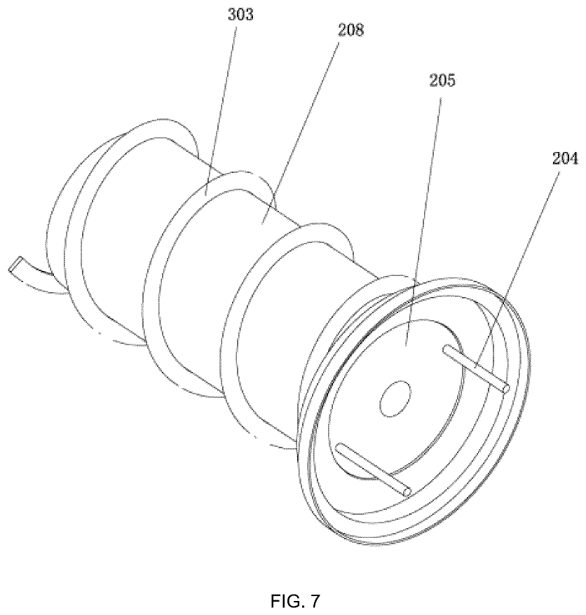

In the second embodiment, as shown in FIG. 5 to FIG. 7, the difference between the second embodiment and the first embodiment lies in that the ice-making assembly 205 further includes a housing 208. An assembly cavity 209 matched with the cold conduction sleeve 205 in shape for placing the cold conduction sleeve 205 is formed in the housing 208. The housing 208 is made of a cold conduction material. The cold conduction sleeve 205 is made of a cold conduction material and is tightly wrapped outside the evaporation pipe 204 so that only the liquid inlet end 206 and the liquid outlet end 207 of the evaporation pipe 204 are exposed to the cold conduction sleeve 205. The evaporation pipe 204 is in full contact with the cold conduction sleeve 205. The cold conduction contact surface is large, and the heat conduction conversion rate is high. The cold conduction sleeve 205 is embedded in the assembly cavity 209 matched with the cold conduction sleeve 205 in shape, and the cold conduction sleeve 205 and the housing 208 are large in cold conduction contact surface and high in heat conduction conversion rate. Therefore, the housing 208 has a good refrigeration effect, and the conversion of liquid beverage form is accelerated. At the same time, the ice-making assembly 203 has good assembly sealing performance.

In the second embodiment of the present disclosure, a cold conduction material (unmarked in figures), like heat conduction silicone grease (including but not limited to) is filled between an inner wall of the assembly cavity 209 and an outer wall of the cold conduction sleeve 205. A cold conduction material is filled between an inner wall of the assembly cavity 209 and an outer wall of the cold conduction sleeve 205, so the cold conduction sleeve 205 and the housing 208 are good in cold conduction effect.

In the second embodiment of the present disclosure, the outer stirring rod 303 spirally extends along the outer wall of the housing 208 in the axial direction of the housing 208. Through the arrangement, the outer stirring rod 303 spirally extending along the outer wall of the housing 208 in the axial direction of the housing 208 is arranged inside the ice-making cavity 101, so the beverage converted into ice particles is always in an irregular motion state under the effect of the outer stirring rod 303 and cannot be increased. The beverage is in a crystalline state like ice particles, and is good in edible effect.

In the second embodiment of the present disclosure, the housing 208 is provided with a temperature sensor 3.

In the second embodiment of the present disclosure, the cold conduction sleeve 205 is locked to the housing 208 through fasteners. Wherein, the fastener may but not limited to a screw. The cold conduction sleeve 205 is locked to the housing 208 through fasteners, so the cold conduction sleeve 205 and the housing 208 are assembled stably, and are unlikely to get loosened and separated.

Compared with an existing evaporation barrel structure, the second embodiment has the advantages of good cold conduction effect, simple structure and simple processing flow (no need for foaming).

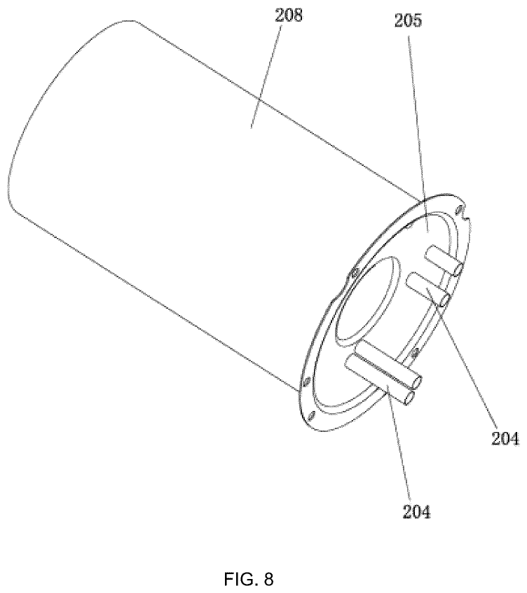

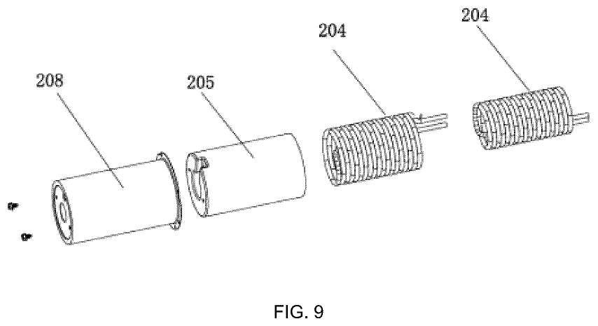

In the third embodiment, as shown in FIG. 8 and FIG. 9, the difference between the third embodiment and the second embodiment lies in that a plurality of groups of evaporation pipes 204 are provided. The plurality of groups of evaporation pipes 204 can be connected in parallel or in series. Or each group of evaporation pipes are connected together as an independent refrigeration unit. Wherein, the scheme of the plurality of independent refrigeration units in parallel connection can control multiple groups to work at the same time or only one group to work through a valve body or an independent system. Wherein, the number of groups of evaporation pipes 204 wrapped by the cold conduction sleeve 205 is determined by specific refrigeration requirements.

It should be understood that the terms “first”, “second” and the like employed in the present disclosure describe various information, but such information should not be limited to these terms. These items are only used to distinguish the same type of information from each other. For example, “first” information could be known as “second” information, and similarly, “second” formation could also be known as “first” information, without departing from the scope of the present disclosure. The indicative direction or position relations of the terms such as “center”, “upper”, “lower”, “left”, “right”, “vertical”, “horizontal”, “inside” and “outside” are direction or position relations illustrated based on the accompanying diagrams, just for facilitating the description of the present disclosure and simplifying the description, but not for indicating or hinting that the indicated device or element must be in a specific direction and is constructed and operated in the specific direction, the terms cannot be understood as the restriction of the present disclosure.

As described above, one or more embodiments are provided in combination with concrete content, and the specific implementation of the present disclosure is not intended to be limited to these descriptions. Approximate and similar methods and structures in the present disclosure, or a plurality of technical deductions and substitutions can be made without departing from the concept of the present disclosure, and should be regarded as the scope of protection of the present disclosure.

1. An ice-making assembly applied to a shaved ice machine, configured in an ice-making cavity of a shaved ice machine, comprising an evaporation pipe and a cold conduction sleeve, wherein the evaporation pipe is provided with a liquid inlet end and a liquid outlet end, the cold conduction sleeve being tightly wrapped outside the evaporation pipe so that only the liquid inlet end and the liquid outlet of the evaporation pipe are exposed to the cold conduction sleeve, and the cold conduction sleeve being made of a cold conduction material.

2. The ice-making assembly applied to a shaved ice machine according to claim 1, further comprising a housing, wherein an assembly cavity matched with the shape of the cold conduction sleeve for placing the cold conduction sleeve is formed in the housing, the housing being made of a heat conduction material.

3. The ice-making assembly applied to a shaved ice machine according to claim 2, further comprising a cold conduction material filled between an inner wall of the assembly cavity and an outer wall of the cold conduction sleeve; and/or wherein the housing is provided with a fastener for locking the housing on the cold conduction sleeve.

4. The ice-making assembly applied to a shaved ice machine according to claim 1, wherein an axial through hole extending along an axial direction of the cold conduction sleeve is formed in the cold conduction sleeve, a hole wall of the axial through hole being defined as an inner cold conduction surface, an outer wall of the cold conduction sleeve being defined as an outer cold conduction surface, and the evaporation pipe being located between the inner cold conduction surface and the outer cold conduction surface.

5. The ice-making assembly applied to a shaved ice machine according to claim 1, wherein the cold conduction sleeve or the housing is provided with a temperature sensor.

6. The ice-making assembly applied to a shaved ice machine according to claim 1, wherein the evaporation pipe extends to the liquid outlet end from the liquid inlet end around the cold conduction sleeve in an axial direction of the cold conduction sleeve.

7. A shaved ice machine, comprising a machine body and an ice-making mechanism arranged in the machine body, and an ice-making cavity being formed in the machine body, wherein the ice-making mechanism comprises an ice-making assembly accommodated in the ice-making cavity, the ice-making assembly being the ice-making assembly applied to a shaved ice machine according to claim 1.

8. The shaved ice machine according to claim 7, wherein the machine body is provided with a stirring mechanism, the stirring mechanism comprising an outer stirring rod accommodated in the ice-making cavity and capable of rotating relative to the cold conduction sleeve, the outer stirring rod spirally extending along an outer wall of the cold conduction sleeve in an axial direction of the cold conduction sleeve.

9. The shaved ice machine according to claim 7, wherein an axial through hole extending along the axial direction of the cold conduction sleeve is formed in the cold conduction sleeve, a hole wall of the axial through hole being defined as an inner cold conduction surface, an outer wall of the cold conduction sleeve being defined as an outer cold conduction sleeve, and the evaporation pipe being located between the inner cold conduction surface and the outer cold conduction surface; and
wherein the machine body is provided with a stirring mechanism, the stirring mechanism comprising an outer stirring rod accommodated in the ice-making cavity and capable of rotating relative to the cold conduction sleeve and an inner stirring rod, the outer stirring rod spirally extending along the outer cold conduction surface in the axial direction of the cold conduction sleeve, and the inner stirring rod spirally extending along the inner cold conduction surface in the axial direction of the cold conduction sleeve.

10. The shaved ice machine according to claim 7, wherein the ice-making assembly further comprises a housing, an assembly cavity matched with the shape of the cold conduction sleeve for placing the cold conduction sleeve being formed in the housing; and
wherein the machine body is provided with a stirring mechanism, the stirring mechanism comprising an outer stirring rod accommodated in the ice-making cavity and capable of rotating relative to the housing, and the outer stirring rod spirally extending along an outer wall of the housing in an axial direction of the housing.
